(19) United States
(12) Patent Application Publication
(10) Pub. No.: US 2003/0109972 A1
(43) Pub. Date: Jun. 12, 2003

(54) Driver's vehicle diagnostic apparatus and early warning

(75) Inventor: Seung-Ho Tak, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: SHT Co., Ltd.

(21) Appl. No.: 10/316,096

(22) Filed: Dec. 11, 2002

Related U.S. Application Data
(60) Provisional application No. 60/339,293, filed on Dec. 12, 2001.

(51) Int. Cl. G06F 7/00

(52) U.S. Cl. 701/29; 705/5

(57) ABSTRACT

A method for diagnosing a vehicle state by connecting a vehicle equipped with an electronic control unit with a personal computer (PC) via a local area network (LAN) communication method, and then connecting the PC to a mechanic center on the Internet, is provided. The vehicle state diagnosing method comprising the steps of: (a) in a first communications module connected to a communications port of the PC, checking whether a registered vehicle approaches within a local area network (LAN) zone; (b) in the PC, driving an electronic control unit diagnosing program, if a response signal is received from the vehicle having a second communications module; (c) in the second communications module, signal-converting diagnosis data output from the electronic control unit installed in the vehicle and storing the conversion result in a memory, and then transmitting the conversion result to the first communications module; and (d) in the case that it is judged that the vehicle is abnormal in the result of analyzing the received diagnosis data in the PC, providing a user with a maintenance method and purchase information of parts, or in the case that a failure cannot be repaired by the user, guiding the user to make reservations with a mechanic center through the Internet. A vehicle diagnostic system of a vehicle equipped with a electronic control unit enables a user to check an abnormality of a vehicle in advance and maintain the vehicle, to thereby greatly reduce a possibility of accidents which may occur during running, and to also make reservations conveniently with a mechanic center with respect to a failure which cannot be repaired by a general user, so that the vehicle can be maintained.

### BACKGROUND OF THE INVENTION

1. Field of the Invention

The present invention relates to a method and system for diagnosing a vehicle equipped with an electronic control unit using the Internet and local area network (LAN) communications, and more particularly to a method and system for diagnosing a basic abnormality of a vehicle equipped with an electronic control unit such as an engine control unit (ECU) or an automatic brake system (ABS), at a personal computer (PC) connected with the vehicle by wireless communications, and reserving a maintenance of a vehicle to a maintenance center connected to the Internet via the PC in the case of a complicated failure which is difficult of a user to maintain it, to thereby enable an ordinary person who is not an expert of a vehicle to easily and efficiently perform a diagnosis of the vehicle.

2. Description of the Related Art

Warning messages notified of to a driver sitting in a driver's seat through a self-diagnostic function of a vehicle are not sufficiently efficient due to a limited display space and restriction of a standard warning display. The displayed contents are also difficult for general drivers. Thus, a service manual for maintenance should be read in order to analyze the displayed contents. Particularly, warning lamps displayed in front of the driver's seat are turned on after most of problems have occurred. Accordingly, if the warning lamps are turned on, the vehicle should be taken to a vehicle mechanic center for a more careful diagnosis of the vehicle.

A vehicle is made up of a several tens of thousand of mechanical components, and thus designed so that some parts and oils should be replaced with new ones. An expert in a vehicle mechanic center who has a professional knowledge or repair experience with respect to a vehicle finds out whether or not the engine of the vehicle is abnormal through a dedicated ECU diagnostic apparatus. However, an ordinary person who is not an expert of a vehicle has a difficulty of easily and efficiently performing a diagnosis of the vehicle. In general, a vehicle diagnoses an abnormality of the vehicle itself and displays a state of the vehicle on an instrumentation panel in front of a driver's seat. However, a display panel displays nothing but a simple warning due to a limited space of the display panel. Thus, it is difficult for a user to recognize a more specific abnormality through such a warning indication. Even minor failure should be checked by a maintenance center.

Recently, commercialized and available vehicles perform a control of an engine and essential components through an electronic control unit. Also, control signals of the electronic control unit are not displayed as an indication easily recognized by a user. Accordingly, a failure cannot be diagnosed without a highly expensive measuring device. As a result, it is not possible for a user to accurately diagnose a vehicle in the case that an abnormality occurred in the vehicle. In this case, even a simple maintenance should be performed by a professional maintenance center. Also, for safe running of a vehicle, engine oil or each consumable should be replaced with new one timely according to each running distance of the vehicle. For this purpose, a user should record a replacement period with respect to each consumable, which causes the user to feel burdensome. Further, in the case that each consumable is not replaced with new one far and away from the replacement period, safe running may be impeded.

### SUMMARY OF THE INVENTION

To solve the above problems, it is an object of the present invention to provide a method and system for diagnosing a vehicle equipped with an electronic control unit with which any one who has no professional knowledge with respect to a vehicle can perform a vehicle diagnosis.

It is another object of the present invention to provide a method and system for diagnosing a vehicle equipped with an electronic control unit for early warning any one who has no professional knowledge with respect to a vehicle of being capable of recognizing whether or not the vehicle is abnormal.

It is still another object of the present invention to provide a method and system for diagnosing a vehicle equipped with an electronic control unit, for enabling any one who has no professional knowledge with respect to a vehicle to perform a vehicle diagnosis, and to make reservations with a vehicle mechanic center for a professional maintenance matter which cannot be repaired by an ordinary person, via the Internet and local area network (LAN) communications.

It is yet another object of the present invention to provide a computer readable recording medium storing a program performing a method for diagnosing a vehicle equipped with an electronic control unit.

To accomplish the above object of the present invention, there is provided a method for diagnosing a vehicle state by connecting a vehicle equipped with an electronic control unit with a personal computer (PC) by cable or wirelessly, and then connecting the PC to a mechanic center on the Internet, the vehicle state diagnosing method comprising the steps of: (a) in a first communications module connected to a communications port of the PC, checking whether a registered vehicle approaches within a local area network (LAN) zone; (b) in the PC, driving an electronic control unit diagnosing program, if a response signal is received from the vehicle having a second communications module; (c) in the second communications module, signal-converting diagnosis data output from the electronic control unit installed in the vehicle and storing the conversion result in a memory, and then transmitting the conversion result to the first communications module; and (d) in the case that it is judged that the vehicle is abnormal in the result of analyzing the received diagnosis data in the PC, providing a user with a maintenance method and purchase information of parts, or in the case that a failure cannot be repaired by the user, guiding the user to make reservations with a mechanic center through the Internet.

Preferably, in step (a), the first communications module connected to the communications port of the PC checks whether the second communications module in the vehicle approaches in a communications zone, through a polling method.

Preferably, if it is checked through the first communications module that a registered vehicle approaches within a communications zone in step (b), the PC is waken up to then automatically execute an electronic control unit diagnosis program installed in the PC.

Preferably, it is checked whether or not a vehicle is a registered vehicle by comparing a vehicle ID set and stored between the first and second communications modules with a received user ID.

Preferably, the PC in step (d) further comprises the steps of receiving a cumulative running distance value of the vehicle from the second communications module and informing the user of a replacement period of the corresponding engine oil and consumable parts according to a running distance.

Preferably, the maintenance method is provided from the PC in the form of a sound signal and a moving video signal.

Preferably, a communication between the first and second communications modules are secured by an encryption key.

There is also provided a system for diagnosing a vehicle equipped with an electronic control unit using the Internet and local area network (LAN) communications, the vehicle diagnosis system comprising: a second communications module installed in the vehicle equipped with the electronic control unit, for storing diagnosis data of the electronic control unit and transmitting the stored diagnosis data according to a control command transmitted from an external source; a first communications module connected to a personal computer (PC), for receiving diagnosis data from the second communications module if it has been checked that a registered vehicle having the second communications module approaches within a communications zone, and waking up the PC to drive an electronic control unit diagnosis program installed in the PC; the PC for analyzing diagnosis data received from the first communications module and displaying the analyzed result on a display, and providing a maintenance method with respect to a corresponding failure in the form of a sound signal and a video signal on a monitor according to a user's set mode in the case that the failure can be easily repaired by a user or transmitting the corresponding diagnosis data to a mechanic center through the Internet and supporting to make reservations with a corresponding vehicle maintenance in the case that the failure cannot be easily repaired by a user; and the mechanic center for receiving vehicle diagnosis data from the PC to thereby make the vehicle diagnosis data into a database, providing a guidance for making a maintenance reservation and purchase information of parts to a user, and performing a maintenance of the vehicle at a maintenance reservation date set by the user.

Preferably, the mechanic center makes maintenance details into a database according to an identification (ID) of the corresponding vehicle and transmits the maintenance details to the PC.

Preferably, the PC stores a replacement period of consumable parts of the vehicle according to a running distance of the vehicle and provides the stored replacement period information to a user.

Preferably, a memory in the second communications module stores information on a vehicle running speed and a cumulative running distance in real time.

Preferably, the memory storing a vehicle running speed in the second communications module is a ring memory.

Preferably, the first and second communications modules are a secure access module (SAM) transmitting and receiving encrypted data, respectively.

Preferably, the second communications module is connected to a car audio system, to receive a user's favorite digital music file transmitted from the PC and provide the received digital music file to the car audio system.

Preferably, the first and second communications modules are set with a vehicle ID and a user ID which are registered in advance.

Preferably, the first communications module connected to the communications port of the PC checks whether the vehicle equipped with the second communications module set with the vehicle ID and the user ID approaches in a communications zone, through a polling method.

Preferably, the first communications module toward the PC performs a diagnosis operation with respect to an electronic control unit of each vehicle having each second communications module by using a window multi-trading function, simultaneously or sequentially.

There is still also provided a computer readable recording medium storing a method for diagnosing a vehicle state in which a vehicle equipped with an electronic control unit is connected to a personal computer (PC) by cable or wirelessly, and the PC is connected to a mechanic center through the Internet, the computer readable recording medium storing programs comprising the steps of: (a) in a first communications module connected to a communications port of the PC, checking whether a registered vehicle approaches within a local area network (LAN) zone; (b) in the PC, driving an electronic control unit diagnosing program, if a response signal is received from the vehicle having a second communications module; (c) in the second communications module, signal-converting diagnosis data output from the electronic control unit installed in the vehicle and storing the conversion result in a memory, and then transmitting the conversion result to the first communications module; and (d) in the case that it is judged that the vehicle is abnormal in the result of analyzing the received diagnosis data in the PC, providing a user with a maintenance method and purchase information of parts, or in the case that a failure cannot be repaired by the user, guiding the user to make reservations with a mechanic center through the Internet.

Also, the present invention provides a driver's vehicle diagnostic apparatus for use in a system for performing a diagnosis of a vehicle and an early warning by connecting a personal computer (PC) and a vehicle on the Internet by use of a local area wireless or wired communications network, characterized in that a local area wireless communications network is used between a local area wireless communications module such as a home network connected to a communications port (USB) in the personal computer (PC) and a wireless communications module installed in an engine control unit (ECU) diagnostic port of the vehicle, and thus, when the vehicle approaches within a communications allowable area of the vehicle, diagnostic functions possessed by one or more controller units such as a vehicle engine are performed by a diagnostic software program installed in the PC, to thereby notify the driver of the diagnosed result, and automatically perform a diagnosis and an early warning after having installed the driver's vehicle diagnostic apparatus.

Preferably, at the process of performing the diagnostic function, speed information output to a diagnostic port of the vehicle is recorded, running distance information is transmitted to a personal computer (PC), information such as periods of time of replacing parts according to the running distance of the vehicle is notified of to a personal database installed in the PC, information such as methods of replacing the parts and prices of the parts is notified of to the driver, and making reservations to a vehicle mechanic center is supported through the Internet with respect to the professional maintenance items which cannot be treated by general drivers.

Preferably, an application software program is provided as a CD-ROM or can be downloaded from an Internet server on the Internet, so that diagnostic functions of an ECU diagnostic apparatus which are used by experts in an existing vehicle mechanic center can be realized as an application software installed in the PC, and the wireless communications module is provided to the diagnostic port of the ECU located in the lower end portion of the driver's seat and the local area wireless communications module is provided to the PC communications port, or a wireless home network is used.

Preferably, only if a VIDN (Vehicle IDentification Number) and a PIN (Personal IDentification Number) should be registered after the wireless communications module has been inserted into the vehicle diagnostic port and the local area wireless communications module has been connected to the USB port of the PC, communications are made to be performed between the vehicle and the PC, in which only both the communications modules can recognize and communicate with each other where a vehicle identification number and a personal secret number are input on a screen provided by the software program of the PC when the communications modules are installed.

Preferably, in the case that a vehicle approaches within the communications allowable area, the driver's vehicle diagnostic apparatus confirms the previously registered VIDN and PIN, automatically requests the vehicle diagnostic port to send a diagnostic command and running distance information, and transfers a vehicle state report as a graphic user circumstance or message which can be recognized by any one who has no professional knowledge, where a driver's vehicle maintenance history database installed in the PC is updated.

Preferably, communications can be performed between only particular wireless communications modules, that is, communications are performed between only communications modules where the VIDNs and PINs coincide with each other, in which the contents of the communications between both the wireless communications modules are encrypted by use of an encryption algorithm implemented as a secure access module (SAM) which is a master communications module firmware, and then transmitted to thereby prevent an illegal use or an abuse of the third party.

Preferably, although power is turned off in a PC main board, a master wireless communications module installed in the PC communications port uses a USB power supplied as an ordinary power, to perform a polling at a predetermined period of time in order to check whether the wireless communications module inserted into the vehicle diagnostic port advances within a communications allowable area, and if a vehicle whose VIDN has been registered advances within a communications allowable area, the diagnostic command is encrypted by the PC diagnostic software program and then the encrypted diagnostic command is transmitted wirelessly to the vehicle communications module, and the vehicle diagnostic response is encrypted by the vehicle encryption software program and then the encrypted vehicle diagnostic response is transmitted wirelessly to the PC communications module.

Preferably, the wireless communications module connected to the vehicle diagnostic port maintains a reception state all the time until a polling signal sent from the PC base station communications module periodically is received, and a microcomputer in the communications module is activated after completion of the registered VIDN and PIN confirmation process, to then perform the diagnostic command and the response process, to thereby prevent a third party from operating the driver's vehicle diagnostic apparatus and prevent communicating with an unregistered vehicle and occurrence of mis-operation.

According to another aspect of the present invention, there is also provided a slave wireless communications module connected to a diagnostic port in a vehicle engine control unit (ECU), for performing functions of transfer error correction and restorage, encryption and decryption, conversion of a diagnostic command transmitted from a personal computer (PC) into an ECU diagnostic command protocol, characterized in that a microcomputer controlling the slave wireless communications module calculates speed information of a vehicle persistently to calculate the speed information and running distance information when the vehicle is running, the running distance information is recorded in a non-volatile memory and the speed information is recorded in a ring memory, the running distance information is recorded as a cumulative distance in a non-volatile memory such as a FeRAM, wherein a past cumulative running distance recorded in the non-volatile memory is reset to be zero if the running distance information is transmitted to the PC and then the PC confirms the reception of the running distance information immediately after communications are performed between the vehicle and the PC.

Also, when a vehicle where a wireless communications module is installed advances within a local area communications allowable area, for example, a garage, the wireless home network module or the PC wireless communications module which is connected to a USB port as an ordinary power wakes up the PC, to thereby communicate with the vehicle wireless communications module to receive the diagnostic information and running distance information.

According to still another aspect of the present invention, there is also provided an early warning system characterized in that daily cumulative running distance information transmitted from a vehicle slave wireless communications module is added in a running distance database installed in a personal computer (PC), messages of replacing engine oil and parts of the vehicle are displayed on a PC screen of a user based on the running distance information stored in a maintenance history database, and thus information on the maintenance of the vehicle is displayed and predicted to the PC by the home network even though the driver forgets all the things with respect to the vehicle, to thereby forecast the following maintenance period of time and contents.

According to yet another aspect of the present invention, there is also provided a second master communications module installed in a vehicle mechanic center, characterized in that a maintenance history is recorded in a memory of a vehicle wireless communications module, via wireless communications when a payment is settled according to the maintenance result, so as to be stored in the memory via the vehicle wireless communications module, if a PIN of a vehicle mechanic center administrator and a VIDN of a vehicle are input into the second master wireless communications module, instead of using a personal password.

According to yet still another aspect of the present invention, there is also provided an input apparatus which can select and input maintenance items from a menu with an arrow direction switch, the input apparatus comprising a simple direction indication input and display unit installed in a vehicle slave wireless communications module.

According to further still another aspect of the present invention, there is also provided a database which is made with a maintenance service manual provided from a vehicle manufacturer based on a cause of an abnormal output value and the corresponding result obtained by comparing a normal value and an abnormal value based on information such as an oxygen sensor output voltage, an intake gas pressure sensor, an internal air temperature, the number of rotations during idling of an engine, to thereby inform a vehicle non-professional person of parts of a vehicle to be repaired and replaced, during diagnosing an engine control unit (ECU) of the vehicle automatically or manually, and information such as procedures of disassembling and reassembling the vehicle parts for maintenance of the vehicle by the non-professional persons for themselves is also provided as a graphic screen in the PC based on a service manual provided for maintenance experts in the vehicle mechanic center from the vehicle manufacturer.

According to yet further still another aspect of the present invention, there is also provided a system for guiding a driver to determine whether a non-professional driver will perform a do-it-yourself (DIY) mode or visit a nearby mechanic center to make reservations for repairing a vehicle through a professional expert, when a guidance graphic database for guiding a vehicle diagnostic and maintenance method provided in a hard disc in a personal computer (PC) or a CD-ROM guides a method and process of replacing parts, or a message of replacing parts according to the running distance, is displayed on a PC screen, and for enabling a reserved time and expense to be displayed as an e-mail when repairing of the vehicle is requested for to the professional expert of the mechanic center, whereby a cost consumed for replacement of the parts, an average repairing time consumed for repairing the parts, and a labor cost and so on are notified of to the driver.

Also, the present invention provides a service for notifying the driver of market price information for parts of the vehicle on a wholesale or retail sale basis by aid of a self-database or Internet parts sellers, supporting purchase of the parts, and informing the driver who is a non-professional person having no professional knowledge of the vehicle of a predicted cost consumed for repairing the parts including replacement information of the parts needed according to the diagnostic result, in the case that the driver has selected the DIY mode.

According to a further aspect of the present invention, there is also provided a black box system for examining a vehicle accident characterized in that speed and frequency sequentially output from a vehicle is recorded in a ring memory at an interval of a second for ten minutes together with a running date and time, on the basis of vehicle speed information recorded in the ring memory.

According to a further aspect of the present invention, there is also provided a wireless communications module characterized in that information such as diagnostic information and running distance information is notified of to a driver via a liquid display device installed in an instrumentation panel board located in front of a driver's seat, by wireless communications, and maintenance information can also be input with a keypad. Music files such as MP3 files are selected and edited in a personal computer (PC), and then transmitted to the vehicle, to thereby enable the driver to listen to the MP3 music, in which a wireless communications diagnostic apparatus is connected to a vehicle audio system during production of the vehicle.

According to a further aspect of the present invention, there is also provided a system characterized in that a slave wireless communications module is attached to a diagnostic port of a vehicle as a part of a royalty service in order to support a wireless diagnostic service at a space in a gas station, and then the vehicle is registered into a personal computer (PC) in the gas station, and that if the vehicle whose licence plate number has been registered in a server arrives at the gas station, it is ascertained whether the VIDN of the vehicle is that of the registered vehicle downloaded in the gas station PC, a diagnostic command is transmitted from a master communications module of the gas station to a slave wireless communications module of the vehicle during filling the vehicle with gas, a diagnostic response is processed in the PC of the gas station, and items to be maintained for every running distance are notified of to the driver, to thereby diagnose the vehicle totally and inform the driver of the diagnostic result.

According to a further aspect of the present invention, there is also provided a method for performing a number of diagnostic operations simultaneously or sequentially and performing a diagnosis by wireless communications using a spread spectral communications system without causing a mutual interference between a number of master and slave wireless communications modules, wherein a window multi-trading function is used in order for slave wireless communications modules installed in a number of vehicles at a space in a gas station to perform n-to-n communications with a number of master wireless communications modules installed in a personal computer (PC) in the gas station, differently from a system where a master wireless communications module in a PC communicates with a slave wireless communications module in a vehicle on a one-to-one communications basis.

### BRIEF DESCRIPTION OF THE DRAWINGS

The above objects and other advantages of the present invention will become more apparent by describing the preferred embodiment thereof in more detail with reference to the accompanying drawings in which:

FIG. 1 shows a system for diagnosing a vehicle equipped with an electronic control unit using the Internet and local area network (LAN) communications according to the present invention;

FIG. 2 is a detailed block diagram showing a second communications module installed in the vehicle of FIG. 1;

FIGS. 3A and 3B are a flowchart view for explaining a diagnostic procedure in the FIG. 1 system; and

FIG. 4 shows an example of a diagnostic procedure screen displayed on a monitor shown in FIG. 1.

### DETAILED DESCRIPTION OF THE INVENTION

Preferred embodiments of the present invention will be described with reference to the accompanying drawings.

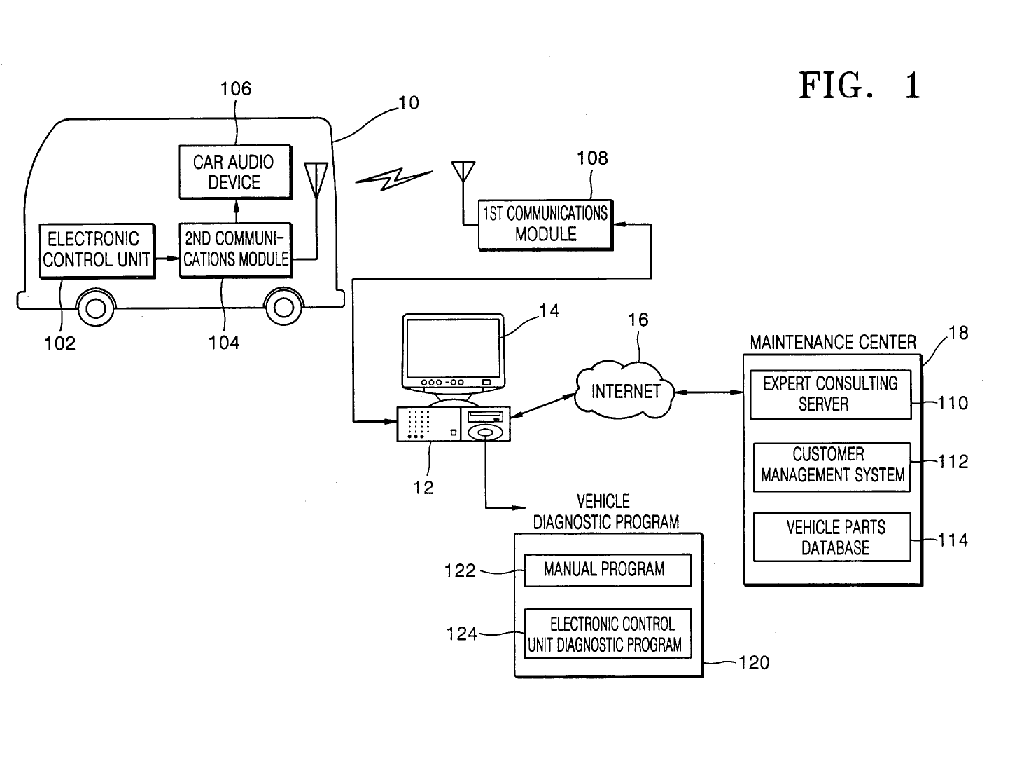

FIG. 1 shows a system for diagnosing a vehicle equipped with an electronic control unit using the Internet and local area network (LAN) communications according to the present invention.

A diagnostic system for diagnosing a vehicle equipped with an electronic control unit such as an engine control unit (ECU) using the Internet, includes a personal computer (PC) 12 in which a vehicle diagnostic program 120 including a manual program 122 and an electronic control unit diagnostic program 124 is installed, a first communications module 108 connected to a universal serial bus (USB) port in the PC 12, and a mechanic center 18 for maintaining a user's vehicle, storing maintenance details as a database and transmitting the stored maintenance details to the PC 12.

The first communications module 108 connected to the PC 12 communicates with a second communications module 104 installed in the vehicle 10, bidirectionally. The first communications module 108 checks whether or not the second communications module 104 approaches within a communications zone through a polling method. When the second communications module 104 has approached within the communications zone, the first communications module 108 checks whether an identification (ID) of the vehicle 10 and a user's ID are registered IDs which were set in advance. If both the vehicle ID and the user's ID are the registered IDs, the PC 12 is waken up to make the PC 12 execute the maintenance program and the diagnostic program installed in the PC 12. The first communications module 108 is connected to the USB port in the PC 12 to receive power stably even in the case that power is turned off, to thereby transmit a polling signal to the second communications module 104.

If the second communications module 104 installed in the vehicle 10 has received a polling signal from the first communications module 108, the vehicle ID and the user's ID are transmitted from the second communications module 108 to the first communications module 104. Accordingly, the vehicle is authenticated as being a registered vehicle. Also, the first communications module 108 is connected to a diagnostic connector in an electronic control unit 102 such as an engine control unit (ECU) or an automatic brake system (ABS) installed in the vehicle 10. The first communications module 108 receives diagnostic data of the electronic control unit 102 and stores the diagnostic data in an internal memory 212, to then transmit the stored diagnostic data to the PC 12. Also, a running speed and a cumulative running distance of the vehicle 10 are stored in a ring memory 206 and a memory 212 on a real time basis during running, respectively. Thus, in the case that the vehicle 10 is in an accident during running, the vehicle diagnostic system according to the present invention provides a function as a black-box which can estimate a situation where the accident was caused. Also, the cumulative running distance data is transmitted to the PC 12 to inform a user of a replacement period of engine oil and consumable parts according to a running distance, respectively. The ring memory 206 stores running speed data for a predetermined time, for example, for about ten minutes. Here, running speed data is sequentially input and stored to the ring memory 206, and then the earliest stored running speed data is shifted out sequentially from the ring memory 206 to thus update running speed data all the time.

The second communications module 104 transmits the running distance data to the PC 12. When the second communications module 104 has received a reception acknowledgement signal from the PC 12, the second communications module 104 resets the stored running distance data and then newly accumulates a running distance value from zero during running, to then be stored in the memory 212.

Also, the first communications module 108 has an anti-collision and high heat-resistant structure to perform a function as a black-box so that data can be safely and securely kept by collision and fire due to a vehicle accident.

The vehicle diagnostic program 120 executed in the PC 12 includes a manual program 122 and an electronic control unit diagnostic program 124, to be displayed as a menu on a monitor 14. The manual program 122 shows a maintenance method with respect to a maker, model, and year of the vehicle to thereby allow a user to easily assemble and disassemble the vehicle 10, in the form of a sound signal through a speaker and a moving video signal on a monitor. The electronic control unit diagnostic program 124 analyzes the diagnostic data of the electronic control unit 102 received from the first communications module 108 toward the PC 12, so that the analyzed result is displayed on the monitor. If a user selects a user maintenance mode, the user maintenance program is executed to guide a maintenance method so that the user can maintain the vehicle directly. Also, if a user judges that he or she cannot maintain the vehicle and selects a mechanic center, the PC 12 is connected to the mechanic center 18 through the Internet, to transmit the data obtained by analyzing the data output from the electronic control unit. The mechanic center 18 provides the user with information about a maintenance reservation according to a diagnostic result of the data output from the electronic control unit, so that the user can make a reservation of a user's desired date and time.

The mechanic center 18 includes an expert consulting server 110 providing a diagnosis with respect to a failure of a vehicle, a customer's management system 112 for managing a history of failure details and replacement of parts of a registered vehicle, and a vehicle parts database 114 storing information about a maker, a model, and year of each vehicle. The mechanic center 18 provides the user's PC 12 with information about an expert's opinion and an on-line prices of each spare part on the basis of the data output from the electronic control unit.

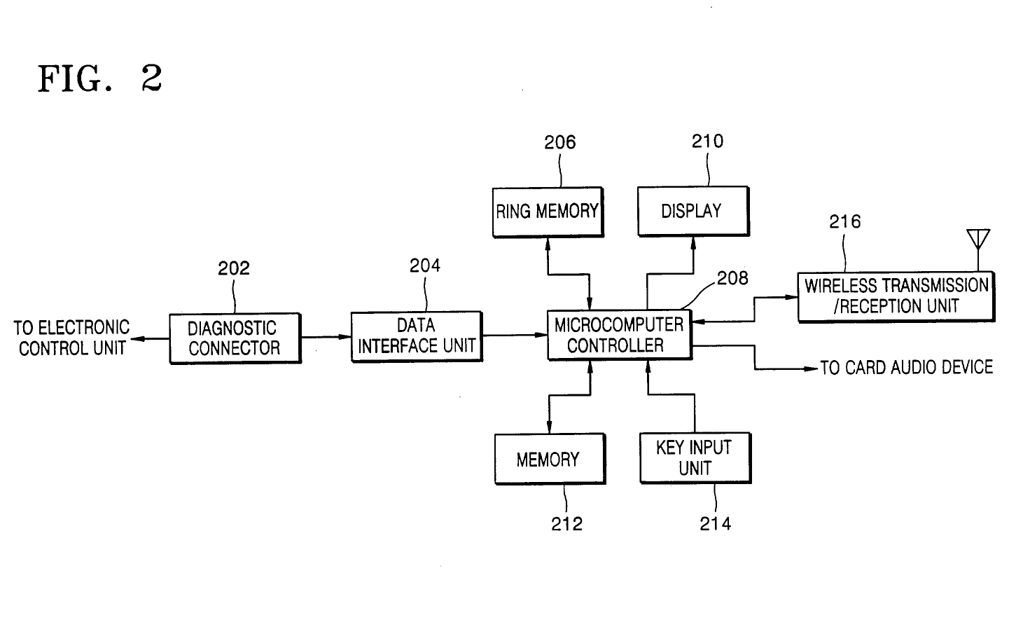

FIG. 2 is a detailed block diagram showing a second communications module installed in the vehicle of FIG. 1.

The second communications module 104 includes a wireless transmission and reception unit 216 for transmitting and receiving wireless data to and from the first communications module 108 connected to the PC 12, a diagnostic connector 202 connected to the electronic control unit 102, for receiving diagnostic data, a data interface unit 204 for classifying the diagnostic data received from the diagnostic connector 202 and transmitting the classified diagnostic data to a microcomputer controller 208, a ring memory 206 storing a vehicle running speed together with date and time data for a predetermined time, a memory 212 storing a security program and a cumulative running distance value, and a display 210 and a key input unit 214 for outputting and inputting data of maintenance details directly from the mechanic center 18, respectively. The ring memory 206 storing the vehicle running speed stores updated running speed data in which data is automatically deleted and updated in a predetermined time, for example, in every ten minutes.

The electronic control unit data received from the diagnostic connector 202 is classified into various kinds of data through the data interface unit 204. Then, if the received data is an analog signal, the analog signal is converted into a digital signal in an analog-to-digital converter (not shown) and the converted result is stored in the memory 212. Then, the digital signal is transmitted ti the first communications module 108 toward the PC 12 via the wireless transmission and reception unit 216. Each element of FIG. 2 is controlled by the microcomputer controller 208. Also, if a digital music file such as a MP3 file stored in the PC 12 is transmitted to the second communications module 104, the second communications module 104 stores the received music file in a memory within a car audio device 106 of FIG. 1, to thereby enable a user to enjoy the music file through the car audio device.

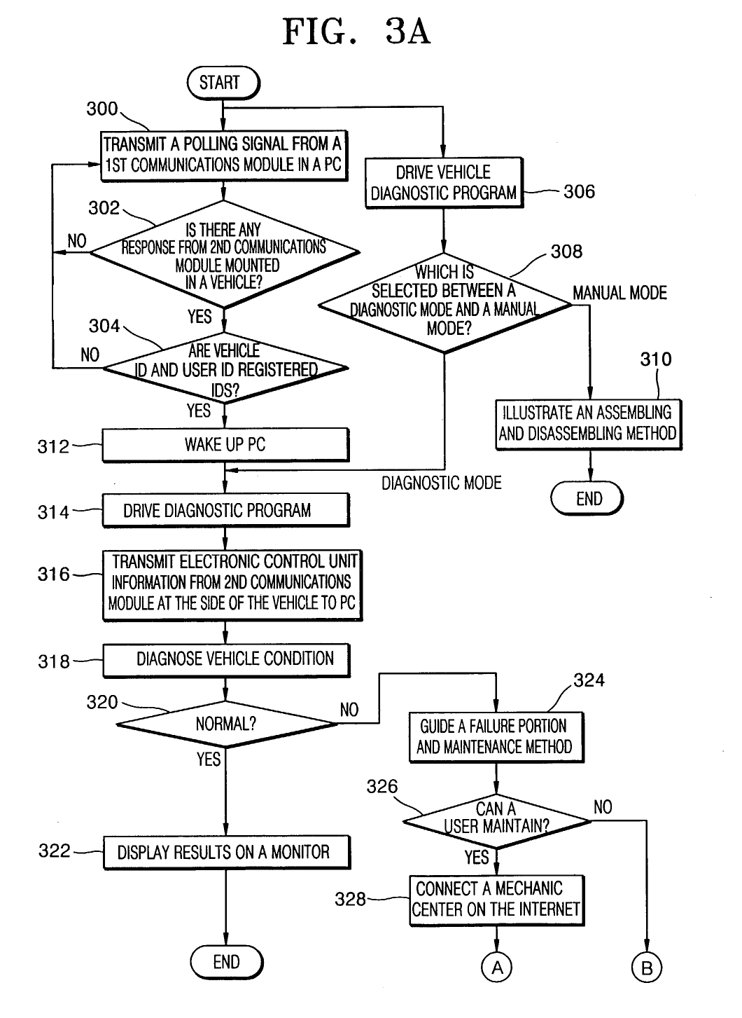

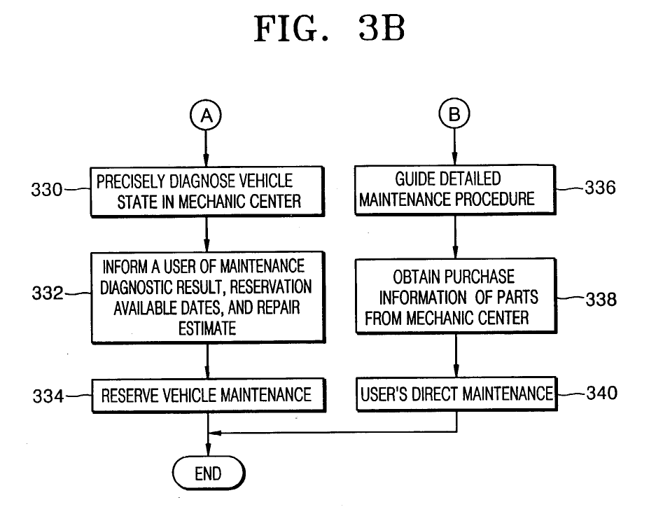

FIGS. 3A and 3B are a flowchart view for explaining a diagnostic procedure using the Internet in a vehicle equipped with an electronic control unit shown in FIG. 1 according to an embodiment of the present invention.

The first communications module 108 connected to a USB port (not shown) in the PC transmits a polling signal in every period, and checks whether a registered vehicle approaches within a nearby communications zone, for example, within 100 meters (steps 300 and 302). If the first communications module 108 receives a response signal with respect to a polling signal from the second communications module 104 installed in the vehicle having approached into the communications zone, the first communications module 108 checks whether the vehicle ID and the user ID transmitted from the second communications module 104 are registered IDs (step 304). If both the vehicle ID and user ID are registered IDs, the connected PC 12 is waken up, to enable the electronic control unit diagnostic program 124 installed in the PC 12 to be executed.

As an alternative method for driving the electronic control unit diagnostic program 124, the user turns the PC 12 on and then directly drives the vehicle diagnostic program 120 (step 306). In this case, the user selects whether a vehicle will be diagnosed or a vehicle manual will be simply referred to from a selection menu displayed on the monitor 14 in the PC 12 (step 308). If the user selects a manual mode, the manual program 122 is executed to then illustrate a vehicle assembling and disassembling method in detail in the form of a moving video signal and a sound signal (step 310). If a diagnosis mode is selected from the selection menu, the program proceeds to step 314 to enable the electronic control unit diagnostic program installed in the PC 12 to be executed.

If the electronic control unit diagnostic program 124 is executed, the PC 12 commands the second communications module 104 to upload the diagnostic data of the electronic control unit 102 through the first communications module 108, in which the diagnostic data is stored in the second communications module 104 (step 314). If the second communications module 104 receives a data transmission command from the PC 12, the diagnostic data from the electronic control unit 102, that is, data of an oxygen sensor output voltage, an inhale pressure sensor, an internal air temperature, the number of rotation of an engine during idling of the engine and so on, is stored in the memory 212 installed in the second communications module 104, to then be transmitted to the PC 12 (step 316). Also, the cumulative running distance value of the vehicle stored in the memory 212 is transmitted to the PC 12.

The electronic control unit diagnostic program 124 in the PC 12 includes a maintenance manual of each vehicle manufacture in the form of a database. Accordingly, the received diagnostic data from the electronic control unit 102 is compared with reference data to judge whether or not the vehicle is abnormal. Here, if the vehicle is judged normal from the received diagnostic data, an indication representing that the vehicle is in a normal condition is displayed on the monitor 14.

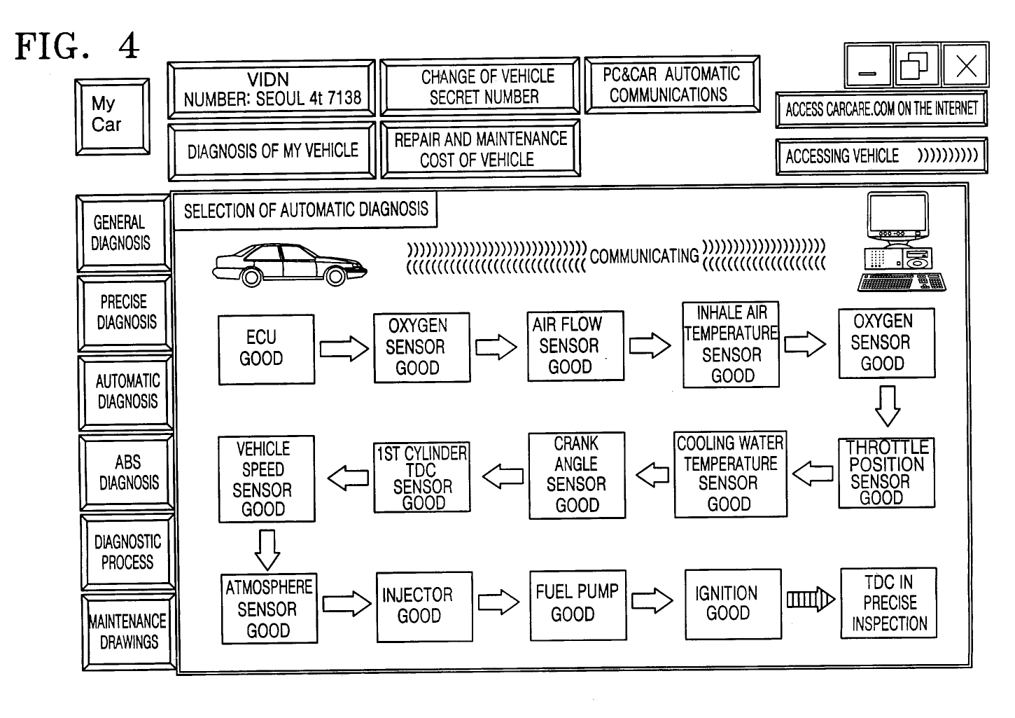

FIG. 4 shows an electronic control unit diagnostic program, showing an example of a diagnostic procedure screen displayed on a monitor shown in FIG. 1. In FIG. 4, the diagnostic data output from an electronic control unit is graphically displayed so that all failure portions can be checked all at a time by a user at a sequential analysis process of the diagnostic data output from the electronic control unit 102.

In the case that the vehicle is judged abnormal from the received electronic control unit data, the electronic control unit diagnostic program 124 analyzes a failure factor, and then guides a failure portion and a maintenance method on the monitor. Here, in the case that a user has no professional knowledge of maintaining a vehicle by using a basic maintenance guidance and method, a mechanic center 18 is selected on the monitor 18, to thereby transmit vehicle condition information to the mechanic center 18 through the Internet 16 (step 328).

The mechanic center 18 precisely diagnoses a vehicle condition on the basis of the electronic control unit data received through the Internet 16 (step 330). For accurate vehicle diagnosis, the mechanic center 18 requests the electronic control unit diagnostic program 124 to diagnose a failure of the vehicle, and transmits an estimate price and maintenance reservation available dates to the PC 12 on the basis of the diagnostic result, to then be displayed on the monitor 14 (step 332). The user selects a date and time which is convenient for maintaining the vehicle among the received maintenance reservation available dates, and completes a vehicle maintenance reservation (step 334).

Meanwhile, if a user selects a do-it-yourself (DIY) mode in step 326, a detailed maintenance procedure with respect to a corresponding failure is guided to the user in the form of a moving video signal and a sound signal at a manual mode (step 336). Also, purchase information on corresponding parts are obtained through the mechanic center 18, so that the user can directly maintain the vehicle with the purchased parts (step 338).

Also, a cumulative running distance value of a vehicle is received in the PC 12. A replacement period of engine oil and consumable parts according to the running distance with respect to the corresponding vehicle is constructed as a database in the PC 12. Accordingly, corresponding consumable parts to be replaced are displayed on the monitor 14 according to the received cumulative running distance value, so that the user can replace the consumable parts in time.

The present invention can be applied to a case that a first communications module is installed in a gas station so that a plurality of registered vehicles can be diagnosed during filling of gas. Also, a user presses a key input unit mounted in a second communications module having a function of transmission of a vehicle ID and a user ID instead of relying upon a polling signal and directly accesses the PC 12 via a LAN communications method, to thereby diagnose a vehicle.

As described above, a vehicle diagnostic system of a vehicle equipped with a electronic control unit according to the present invention enables a user to check an abnormality of a vehicle in advance and maintain the vehicle, to thereby greatly reduce a possibility of accidents which may occur during running. Also, the present invention can make reservations conveniently with a mechanic center with respect to a failure which cannot be repaired by a general user, to thereby maintain the vehicle.

As described above, the present invention provides a vehicle diagnostic system with which any one who has no professional knowledge with respect to a vehicle can perform a vehicle diagnosis easily and efficiently. Also, the present invention provides an early warning system for warning any one who has no professional knowledge with respect to a vehicle of being capable of recognizing whether or not the vehicle is abnormal. Further, the present invention provides a system for enabling any one who has no professional knowledge with respect to a vehicle to make reservations for a professional maintenance matter which cannot be repaired by an ordinary person with respect to a vehicle mechanic center.

As described above, the present invention has been described with respect to the particularly preferred embodiments, but the present invention is not limited in the above-described embodiments. It is apparent to one who has an ordinary skill in the art that there are many variations and modifications within the scope of the appended claims with departing off from the spirit of the present invention.

What is claimed is:

1. A method for diagnosing a vehicle state by connecting a vehicle equipped with an electronic control unit with a personal computer (PC) by cable or wirelessly, and then connecting the PC to a mechanic center on the Internet, the vehicle state diagnosing method comprising the steps of:
(a) in a first communications module connected to a communications port of the PC, checking whether a registered vehicle approaches within a local area network (LAN) zone;
(b) in the PC, driving an electronic control unit diagnosing program, if a response signal is received from the vehicle having a second communications module;
(c) in the second communications module, signal-converting diagnosis data output from the electronic control unit installed in the vehicle and storing the conversion result in a memory, and then transmitting the conversion result to the first communications module; and
(d) in the case that it is judged that the vehicle is abnormal in the result of analyzing the received diagnosis data in the PC, providing a user with a maintenance method and purchase information of parts, or in the case that a failure cannot be repaired by the user, guiding the user to make reservations with a mechanic center through the Internet.

2. The electronic control unit mounted vehicle diagnostic method of claim 1, wherein in step (a), the first communications module connected to the communications port of the PC checks whether the second communications module in the vehicle approaches in a communications zone, through a polling method.

3. The electronic control unit mounted vehicle diagnostic method of claim 1, wherein if it is checked through the first communications module that a registered vehicle approaches within a communications zone in step (b), the PC is waken up to then automatically execute an electronic control unit diagnosis program installed in the PC.

4. The electronic control unit mounted vehicle diagnostic method of claim 1, wherein it is checked whether or not a vehicle is a registered vehicle by comparing a vehicle ID set and stored between the first and second communications modules with a received user ID.

5. The electronic control unit mounted vehicle diagnostic method of claim 1, wherein the PC in step (d) further comprises the steps of receiving a cumulative running distance value of the vehicle from the second communications module and informing the user of a replacement period of the corresponding engine oil and consumable parts according to a running distance.

6. The electronic control unit mounted vehicle diagnostic method of claim 1, wherein the maintenance method is provided from the PC in the form of a sound signal and a moving video signal.

7. The electronic control unit mounted vehicle diagnostic method of claim 1, wherein a communication between the first and second communications modules are secured by an encryption key.

8. A system for diagnosing a vehicle equipped with an electronic control unit using the Internet and local area network (LAN) communications, the vehicle diagnosis system comprising:
a second communications module installed in the vehicle equipped with the electronic control unit, for storing diagnosis data of the electronic control unit and transmitting the stored diagnosis data according to a control command transmitted from an external source;
a first communications module connected to a personal computer (PC), for receiving diagnosis data from the second communications module if it has been checked that a registered vehicle having the second communications module approaches within a communications zone, and waking up the PC to drive an electronic control unit diagnosis program installed in the PC;
the PC for analyzing diagnosis data received from the first communications module and displaying the analyzed result on a display, and providing a maintenance method with respect to a corresponding failure in the form of a sound signal and a video signal on a monitor according to a user's set mode in the case that the failure can be easily repaired by a user or transmitting the corresponding diagnosis data to a mechanic center through the Internet and supporting to make reservations with a corresponding vehicle maintenance in the case that the failure cannot be easily repaired by a user; and
the mechanic center for receiving vehicle diagnosis data from the PC to thereby make the vehicle diagnosis data into a database, providing a guidance for making a maintenance reservation and purchase information of parts to a user, and performing a maintenance of the vehicle at a maintenance reservation date set by the user.

9. The electronic control unit mounted vehicle diagnostic system of claim 8, wherein the mechanic center makes maintenance details into a database according to an identification (ID) of the corresponding vehicle and transmits the maintenance details to the PC.

10. The electronic control unit mounted vehicle diagnostic system of claim 8, wherein the PC stores a replacement period of consumable parts of the vehicle according to a running distance of the vehicle and provides the stored replacement period information to a user.

11. The electronic control unit mounted vehicle diagnostic system of claim 8, wherein a memory in the second communications module stores information on a vehicle running speed and a cumulative running distance in real time.

12. The electronic control unit mounted vehicle diagnostic system of claim 8, wherein the memory storing a vehicle running speed in the second communications module is a ring memory.

13. The electronic control unit mounted vehicle diagnostic system of claim 8, wherein the first and second communications modules are a secure access module (SAM) transmitting and receiving encrypted data, respectively.

14. The electronic control unit mounted vehicle diagnostic system of claim 8, wherein the second communications module is connected to a car audio system, to receive a user's favorite digital music file transmitted from the PC and provide the received digital music file to the car audio system.

15. The electronic control unit mounted vehicle diagnostic system of claim 8, wherein the first and second communications modules are set with a vehicle ID and a user ID which are registered in advance.

16. The electronic control unit mounted vehicle diagnostic system of claim 8, wherein the first communications module connected to the communications port of the PC checks whether the vehicle equipped with the second communications module set with the vehicle ID and the user ID approaches in a communications zone, through a polling method.

17. The electronic control unit mounted vehicle diagnostic system of claim 8, wherein the first communications module toward the PC performs a diagnosis operation with respect to an electronic control unit of each vehicle having each second communications module by using a window multi-trading function, simultaneously or sequentially.

18. A computer readable recording medium storing a method for diagnosing a vehicle state in which a vehicle equipped with an electronic control unit is connected to a personal computer (PC) by cable or wirelessly, and the PC is connected to a mechanic center through the Internet, the computer readable recording medium storing programs comprising the steps of:
(a) in a first communications module connected to a communications port of the PC, checking whether a registered vehicle approaches within a local area network (LAN) zone;
(b) in the PC, driving an electronic control unit diagnosing program, if a response signal is received from the vehicle having a second communications module;
(c) in the second communications module, signal-converting diagnosis data output from the electronic control unit installed in the vehicle and storing the conversion result in a memory, and then transmitting the conversion result to the first communications module; and
(d) in the case that it is judged that the vehicle is abnormal in the result of analyzing the received diagnosis data in the PC, providing a user with a maintenance method and purchase information of parts, or in the case that a failure cannot be repaired by the user, guiding the user to make reservations with a mechanic center through the Internet.
